(19) United States
(12) Patent Application Publication
(10) Pub. No.: US 2008/0025893 A1
(43) Pub. Date: Jan. 31, 2008

(54) Method For The Removal Of Carbon Dioxide From Gas Flows With Low Carbon Dioxide Partial Pressures

(75) Inventors: Norbert Asprion, Ludwigshafen (DE); Iven Clausen, Mannheim (DE); Ute Lichtfers, Karlsruhe (DE)

Correspondence Address: CONNOLLY BOVE LODGE & HUTZ LLP, 1875 EYE STREET, N.W., SUITE 1100, WASHINGTON, DC, 20036, US

(73) Assignee: BASF Aktiengesellschaft, Ludwigshafen (DE)

(21) Appl. No.: 10/592,420

(22) PCT Filed: Mar. 9, 2005
(86) PCT No.: PCT/EP05/02498

§ 371 Date: Jul. 13, 2007

(30) Foreign Application Priority Data
Mar. 9, 2004 (DE) 10 2004 011 429.3

(51) Int. Cl. B01D 53/14

(52) U.S. Cl. 423/228; 252/184

(57) ABSTRACT

The invention relates to a method for the removal of carbon dioxide from a gas flow with a carbon dioxide partial pressure in the gas flow of less than 200 mbar, whereby the gas flow is brought into contact with a liquid absorption agent, selected from an aqueous solution (A) of an amino compound with at least two tertiary amino groups in the molecule and (B) an activator, selected from the primary and secondary amines, or (A) a tertiary aliphatic amine, the reaction enthalpy Δ_{R}H for the protonation of which is greater than that for methyldiethanolamine and (B) an activator, selected from 3-methylaminopropylamine, piperazine, 2-methylpiperazine, N-methylpiperazine, homopiperazine, piperidine and morpholine. The method is particularly suitable for the treatment of flue gases and also relates to an absorption agent.

### The present invention relates to a process for removing carbon dioxide from gas streams having low carbon dioxide partial pressures, in particular for removing carbon dioxide from flue gases.

Removing carbon dioxide from flue gases is desirable for various reasons, but in particular for reducing the emission of carbon dioxide which is considered the main reason for what is termed the greenhouse effect.

On an industrial scale, aqueous solutions of organic bases, for example alkanolamines, are frequently used as absorption media for removing acid gases, such as carbon dioxide, from fluid streams. When acid gases dissolve, ionic products are formed from the base and the acid gas constituents. The absorption medium can be regenerated by heating, expansion to a lower pressure or by stripping, with the ionic products back-reacting to form acid gases and/or the acid gases being stripped off by steam. After the regeneration process, the absorption medium can be reused.

Flue gases have very low carbon dioxide partial pressures, since they are generally produced at a pressure close to atmospheric pressure and typically comprise from 3 to 13% by volume of carbon dioxide. To achieve effective removal of carbon dioxide, the absorption medium must have a high acid gas affinity, which generally means that the carbon dioxide absorption proceeds strongly exothermically. On the other hand, the high amount of the absorption reaction enthalpy causes increased energy demand during the regeneration of the absorption medium.

Dan G. Chapel et al. therefore recommend, in their paper “Recovery of CO₂ from Flue Gases: Commercial Trends” (presented at the annual meeting of the Canadian Society of Chemical Engineers, 4-6 Oct., 1999, Saskatoon, Saskatchewan, Canada), selecting an absorption medium having a relatively low reaction enthalpy to minimize the required regeneration energy.

It is an object of the present invention to specify a process which permits thorough removal of carbon dioxide from gas streams having low carbon dioxide partial pressures and in which it is possible to regenerate the absorption medium with relatively low energy consumption.

EP-A 558 019 describes a process for removing carbon dioxide from combustion gases in which the gas is treated at atmospheric pressure with an aqueous solution of a sterically hindered amine, such as 2-amino-2-methyl-1-propanol, 2-(methylamino)-ethanol, 2-(ethylamino)ethanol, 2-(diethylamino)ethanol and 2-2-hydroxyethyl)-piperidine. EP-A 558 019 also describes a process in which the gas is treated at atmospheric pressure with an aqueous solution of an amine such as 2-amino-2-methyl-1,3-propanediol, 2-amino-2-methyl-1-propanol, 2-amino-2-ethyl-1,3-propanediol, t-butyldiethanolamine and 2-amino-2-hydroxymethyl-1,3-propanediol, and an activator such as piperazine, piperidine, morpholine, glycine, 2-methylaminoethanol, 2-piperidineethanol and 2-ethylaminoethanol.

EP-A 879 631 discloses a process for removing carbon dioxide from combustion gases in which the gas is treated at atmospheric pressure with an aqueous solution of one secondary amine and one tertiary amine.

EP-A 647 462 describes a process for removing carbon dioxide from combustion gases in which the gas is treated at atmospheric pressure with an aqueous solution of a tertiary alkanolamine and an activator such as diethylenetriamine, triethylenetetramine, tetraethylenepentamine; 2,2-dimethyl-1,3-diaminopropane, hexamethylenediamine, 1,4-diaminobutane, 3,3-iminotrispropylamine, tris(2-aminoethyl)amine, N-(2-aminoethyl)piperazine, 2-(aminoethyl)ethanol, 2-(methylamino)ethanol, 2-(n-butyl-amino)ethanol.

We have found that this object is achieved by a process for removing carbon dioxide from a gas stream in which the partial pressure of the carbon dioxide in the gas stream is less than 200 mbar, usually from 20 to 150 mbar, which comprises bringing the gas stream into contact with a liquid absorption medium which comprises an aqueous solution of

(A) an amine compound having at least two tertiary amino groups in the molecule and

(B) an activator which is selected from primary and secondary amines.

We have also found that this object is achieved by a process for removing carbon dioxide from a gas stream in which the partial pressure of the carbon dioxide in the gas stream is less than 200 mbar, which comprises bringing the gas stream into contact with a liquid absorption medium which comprises an aqueous solution of

(A) a tertiary aliphatic amine and

(B) an activator which is selected from 3-methylaminopropylamine, piperazine, 2-methylpiperazine, N-methylpiperazine, homopiperazine, piperidine and morpholine,

wherein the tertiary aliphatic amine A is characterized by a reaction enthalpy Δ_{R}H of the protonation reaction

A+H⁺→AH⁺

which is greater than that of methyidiethanolamine.

Preferably, the amine compound has the general formula

R^{a}R^{b}N—X—NR^{a}′R^{b}′,

where R^{a}, R^{b}, R^{a}′ and R^{b}′ independently of one another are selected from C₁-C₆-alkyl groups, C₂-C₆-hydroxyalkyl groups, or C₁-C₆-alkoxy-C₂-C₆-alkyl groups and X is a C₂-C₆-alkylene group, —X¹—NR—X²— or —X¹—O—X²—, where X¹ and X² independently of one another are C₂-C₆-alkylene groups and R is a C₁-C₆-alkyl group.

In preferred embodiments, R^{a}, R^{b}, R^{a}′ and R^{b}′ independently of one another are methyl or ethyl.

X is preferably a C₂-C₃-alkylene group, —X¹—NR—X²— or —X¹—O—X²—, where X¹ and X² independently of one another are C₂-C₃-alkylene groups and R is a C₁-C₂-alkyl group.

Particularly preferred amine compounds are N,N,N′,N′-tetramethylethylenediamine, N,N-diethyl-N′, N′-dimethylethylenediamine, N, N,N′, N′-tetraethylethylenediamine, N′,N,N′,N′-tetramethyl-1,3-propanediamine and N,N, N′,N′-tetraethyl-1,3-propanediamine and also bis(dimethylaminoethyl)ether.

The activator is preferably selected from

a) 5- or 6-membered saturated heterocycles containing at least one NH group in the ring which can contain one or two more heteroatoms in the ring, selected from nitrogen and oxygen, or

b) compounds of the formula R¹—NH—R²—NH₂, where R¹ is C₁-C₆-alkyl and R² is C₂-C₆-alkylene.

Examples of preferred activators are piperazine, 2-methylpiperazine, N-methyl-piperazine, homopiperazine, piperidine and morpholine and also 3-methyl-aminopropylamine.

As component (A), use can also be made of mixtures of various amine compounds, or as component (B), use can be made of mixtures of various activators.

Preferably, the amine compound has a pKₐ value (measured at 25° C.; 1 mol/l) of from 9 to 11, in particular from 9.3 to 10.5. In the case of polybasic amines, at least one pKₐ is in the range specified.

The amine compounds used according to the invention are characterized by an amount of the reaction enthalpy Δ_{R}H of the protonation reaction

A⁺H⁺→AH⁺

(where A is the tertiary aliphatic amine) which is greater than that of methyldiethanolamine (at 25° C., 1013 mbar). The reaction enthalpy Δ_{R}H of the protonation reaction for methyldiethanolamine is about −35 kJ/mol.

The reaction enthalpy ARH may be estimated to a good approximation from the pKs at differing temperatures using the following equation:

Δ_{R}H=R*(pK_{₁}_{-pK}_{₂})/(1/T₁−1/T₂)*ln (10)

A compilation of the ARH values calculated from the above equation for various tertiary amines may be found in the following table:

| | | | Reaction |
|---|---|---|---|
| | | | enthalpy − |
| Amine | pK₁ (T₁) | pK₂ (T₂) | Δ_{R}H/kJ/mol |
| N-Methyldiethanolamine | 8.52 (298 K) | 7.87 (333 K) | 35 |
| (MDEA) | | | |
| N,N-Diethylethanolamine | 9.76 (293 K) | 8.71 (333 K) | 49 |
| (DEEA) | | | |
| N,N-Dimethylethanolamine | 9.23 (293 K) | 8.36 (333 K) | 41 |
| (DMEA) | | | |
| 2-Diisopropylaminoethanol | 10.14 (293 K) | 9.13 (333 K) | 47 |
| (DIEA) | | | |
| N,N,N′,N′- | 9.8 (298 K) | 9.1 (333 K) | 38 |
| Tetramethylpropane- | | | |
| diamine (TMPDA) | | | |
| N,N,N′,N′- | 10.5 (298 K) | 9.7 (333 K) | 43 |
| Tetraethylpropanediamine | | | |
| (TEPDA) | | | |
| 1-Dimethylamino-2- | 8.9 (298 K) | 8.2 (333 K) | 38 |
| dimethylamino- | | | |
| ethoxyethane (Niax) | | | |
| N,N-Dimethyl-N′,N′- | 9.6 (298 K) | 8.9 (333 K) | 38 |
| diethylethylene-diamine | | | |
| (DMDEEDA) | | | |

Surprisingly, amines having a relatively high level of reaction enthalpy Δ_{R}H are suitable for the inventive process. This is thought to be due to the fact that the temperature dependence of the equilibrium constants of the protonation reaction is proportional to the reaction enthalpy Δ_{R}H. In the case of amines having high reaction enthalpy Δ_{R}H, the temperature dependence of the position of the protonation equilibrium is more strongly expressed. Since the regeneration of the absorption medium is performed at higher temperature than the absorption step, absorption media are successfully prepared which, in the absorption step, permit effective removal of carbon dioxide even at low carbon dioxide partial pressures, but can be regenerated with a relatively low energy input.

Customarily the concentration of the amine compound is from 20 to 60% by weight, preferably from 25 to 50% by weight, and the concentration of the activator is from 1 to 10% by weight, preferably from 2 to 8% by weight, based on the total weight of the absorption medium.

The amines are used in the form of their aqueous solutions. The solutions can in addition comprise physical solvents which are selected, for example, from cyclotetramethylene sulfone (sulfolane) and derivatives thereof, aliphatic acid amides (acetylmorpholine, N-formylmorpholine), N-alkylated pyrrolidones and corresponding piperidones, such as N-methylpyrrolidone (NMP), propylene carbonate, methanol, dialkyl ethers of polyethylene glycols and mixtures thereof.

The absorption medium according to the invention may comprise further functional components such as stabilizers, in particular antioxidants, cf. e.g. DE 10200411427.

Where present, in addition to carbon dioxide in the inventive process, customarily other acid gases, for example H₂S, SO₂, CS₂, HCN, COS, NO₂, HCl, disulfides or mercaptans, are also removed from the gas stream.

The gas stream is generally a gas stream which is formed in the following manner:

a) oxidation of organic substances, for example flue gases,

b) composting and storing waste material comprising organic substances, or

c) bacterial decomposition of organic substances.

The oxidation can take place with appearance of flame, that is to say as conventional combustion, or as oxidation without appearance of flame, for example in the form of a catalytic oxidation or partial oxidation. Organic substances which are subjected to the combustion are customarily fossil fuels, such as coal, natural gas, petroleum, gasoline, diesel, raffinates or kerosene, biodiesel or waste material having a content of organic substances. Starting substances of the catalytic (partial) oxidation are, for example, methanol or methane, which can be converted to formic acid or formaldehyde.

Waste material which is subjected to the oxidation, composting or storage, is typically domestic refuse, plastic waste or packaging refuse.

The organic substances are usually burnt with air in conventional incineration plants. The composting and storage of waste material comprising organic substances is generally performed at refuse landfills. The off-gas or the exhaust air of such plants can advantageously be treated by the inventive process.

Organic substances used for bacterial decomposition are customarily stable manure, straw, liquid manure, sewage sludge, fermentation residues and the like. The bacterial decomposition takes place, for example, in customary biogas plants. The exhaust air of such plants can advantageously be treated by the inventive process.

The process is also suitable for treating the off-gases of fuel cells or chemical synthesis plants which are used for (partial) oxidation of organic substances.

In addition, the inventive process can, of course, also be used to treat unburnt fossil gases, for example natural gas, for example what are termed coal seam gases, that is to say gases arising in the extraction of coal which are collected and compressed.

Generally, these gas streams, under standard conditions, comprise less than 50 mg/m³ as sulfur dioxide.

The starting gases can either have the pressure which roughly corresponds to the pressure of the ambient air, that is to say for example atmospheric pressure, or a pressure which deviates from atmospheric pressure by up to 1 bar.

Suitable apparatuses for carrying out the inventive process comprise at least one scrubbing column, for example random packing element, ordered packing element and tray columns, and/or other absorbers such as membrane contactors, radial-stream scrubbers, jet scrubbers, venturi scrubbers and rotary spray scrubbers. The gas stream is treated with the absorption medium, preferably in a scrubbing column in counter-current flow. The gas stream is generally fed in in this case to the lower region and the absorption medium to the upper region of the column.

Suitable apparatuses for carrying out the inventive process are also scrubbing columns made of plastic, such as polyolefins or polytetrafluoroethylene, or scrubbing columns whose inner surface is wholly or partly lined with plastic or rubber. In addition, membrane contactors having a plastic housing are suitable.

The temperature of the absorption medium in the absorption step is generally from about 30 to 70° C., when a column is used, for example from 30 to 60° C. at the top of the column and from 40 to 70° C. at the bottom of the column. A product gas (by-gas) which is low in acid gas constituents, that is to say which is depleted in these constituents, is obtained and an absorption medium loaded with acid gas constituents is-obtained.

Generally, the loaded absorption medium is regenerated by

a) heating, for example to from 70 to 110° C.,

b) expansion,

c) stripping with an inert fluid,

or a combination of two or all of these measures.

Generally, the loaded absorption medium is heated for regeneration and the released carbon dioxide is separated off, for example, in a desorption column. Before the regenerated absorption medium is reintroduced into the adsorber, it is cooled to a suitable absorption temperature. To utilize the energy present in the hot regenerated absorption medium, it is preferred to preheat the loaded absorption medium from the absorber by heat exchange with the hot regenerated absorption medium. The heat exchange brings the loaded absorption medium to a higher temperature so that in the regeneration step a smaller energy input is required. By means of the heat exchange, a partial regeneration of the loaded absorption medium with release of carbon dioxide can also take place as early as this. The resultant gas-liquid mixed phase stream is passed into a phase-separation vessel from which the carbon dioxide is taken off; the liquid phase is passed into the desorption column for complete regeneration of the absorption medium.

Frequently, the carbon dioxide released in the desorption column is subsequently compressed and fed, for example, to a pressure tank or to sequestration. In these cases, it can be advantageous to carry out regeneration of the absorption medium at an elevated pressure, for example 2 to 10 bar, preferably 2.5 to 5 bar. The loaded absorption medium for this is compressed to the regeneration pressure using a pump and introduced into the desorption column. The carbon dioxide arises at a higher pressure level in this manner. The pressure difference to the pressure level of the pressure tank is less and in some circumstances a compression stage can be omitted. A higher pressure in regeneration necessitates a higher regeneration temperature. At a higher regeneration temperature, a lower residual loading of the absorption medium can be achieved. The regeneration temperature is generally limited only by the thermal stability of the absorption medium.

Before the inventive absorption medium treatment, the flue gas is preferably subjected to a scrubbing with an aqueous liquid, in particular with water, to cool the flue gas and moisten it (quench). During the scrubbing, dusts or gaseous impurities such as sulfur dioxide can also be removed.

The invention is described in more detail on the basis of the accompanying figure.

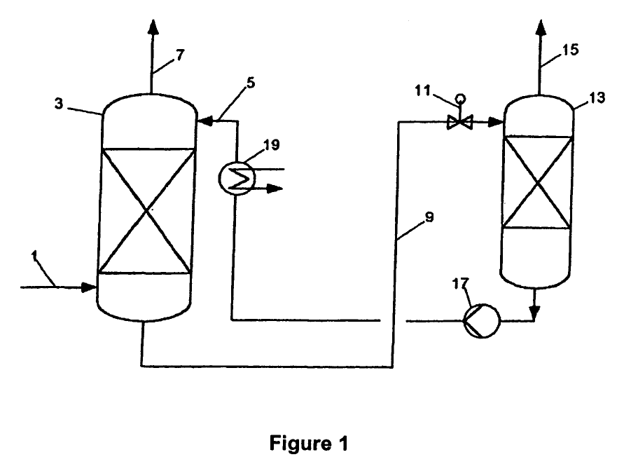

FIG. 1 is a diagrammatic representation of a plant suitable for carrying out the inventive process.

According to FIG. 1, a suitably pretreated combustion gas which comprises carbon dioxide is brought into contact in counter-current flow in an absorber 3 with the regenerated absorption medium which is fed by the absorption medium line 5. The absorption medium removes carbon dioxide from the combustion gas by absorption; in the process a clean gas which is low in carbon dioxide is produced via an off-gas line 7. The absorber 3 can have (which is not shown), above the absorption medium inlet, backwash trays or backwash sections which are preferably equipped with packings, where entrained absorption medium is separated off from the CO₂-depleted gas using water or condensate. The liquid on the backwash tray is recycled in a suitable manner via an external cooler.

Via an absorption medium line 9 and a throttle valve 11, the carbon-dioxide-loaded absorption medium is passed through a desorption column 13. In the lower part of the desorption column 13 the loaded absorption medium is heated and regenerated by means of a heater (which is not shown). The resultant carbon dioxide which is released leaves the desorption column 13 via the off-gas line 15. The desorption column 13 can have (which is not shown), above the absorption medium inlet, backwash trays or backwash sections which are preferably equipped with packings, where entrained absorption medium is separated off from the released CO₂ using water or condensate. In line 15, a heat exchanger having a top distributor or condenser can be provided. The regenerated absorption medium is then fed back to the absorption column 3 by means of a pump 17 via a heat exchanger 19. To prevent the accumulation of absorbed substances which are not expelled, or are expelled only incompletely in the regeneration, or of decomposition products in the absorption medium, a substream of the absorption medium taken off from the desorption column 13 can be fed to an evaporator in which low-volatile byproducts and decomposition products arise as residue and the pure absorption medium is taken off as vapors. The condensed vapors are recirculated to the absorption medium circuit. Expediently, a base, such as potassium hydroxide, can be added to the substream, which base forms, for example together with sulfate or chloride ions, low-volatile salts, which are taken off from the system together with the evaporator residue.

### EXAMPLES

In the examples hereinafter, the following abbreviations are used:
DMEA: N,N-dimethylethanolamine
DEEA: N,N-diethylethanolamine
TMPDA: N,N,N′,N′-tetramethylpropanediamine
MDEA: N-methyldiethanolamine
MAPA: 3-methylaminopropylamine
Niax: 1-dimethylamino-2-dimethylaminoethoxyethane

All percentages are percentages by weight.

### Example 1

### CO₂ Mass Transfer Rate

The mass transfer rate was determined in a laminar jet chamber using water vapor-saturated CO₂ at 1 bar and 50° C. and 70° C., jet chamber diameter 0.94 mm, jet length 1 to 8 cm, volumetric flow rate of the absorption medium 1.8 mils and is reported as gas volume in cubic meters under standard conditions per unit surface area of the absorption medium, pressure and time (Nm³/m²/bar/h). p The results are summarized in the following table 1. The CO₂ mass transfer rate reported in the table is related to the CO₂ mass transfer rate of a comparison absorption medium, which comprises 35% by weight MDEA and 5% by weight piperazine.

TABLE 1

| Amine | Activator | Temperature | Relative CO₂ mass |
|---|---|---|---|
| [35% by weight] | [5% by weight] | [° C.] | transfer rate [%] |
| DEEA | Piperazine | 50 | 121.60 |
| DEEA | Piperazine | 70 | 117.24 |
| TMPDA | Piperazine | 50 | 157.60 |
| TMPDA | Piperazine | 70 | 145.98 |

### Example 2

### CO₂ Uptake Capacity and Regeneration Energy Requirement

To determine the capacity of various absorption media for the uptake of CO₂ and to estimate the energy consumption in the regeneration of the absorption media, firstly measured values were determined for the CO₂ loading at 40 and 120° C. under equilibrium conditions. These measurements were carried out for the systems CO₂/Niax/MAPA/water; CO₂/TMPDA/MAPA/water; CO₂/DEEA/MAPA/water; CO₂/DMEA/MAPA/water; CO₂/Niax/piperazine/water; CO₂/TMPDA/piperazine/water in a glass pressure vessel (volume=110 cm³ or 230 cm³), in which a defined amount of the absorption medium had been charged, evacuated and, at constant temperature, carbon dioxide was added stepwise via a defined gas volume. The amount of carbon dioxide dissolved in the liquid phase was calculated after gas space correction of the gas phase. The equilibrium measurements for the system CO₂/MDEA/MAPA/water were performed in the pressure range>1 bar using a high pressure equilibrium cell; in the pressure range<1 bar, the measurements were carried out using headspace chromatography. The equilibrium data for the system CO₂/MDEA/piperazine/water were calculated according to the electrolyte approach of Pitzer (Kenneth S. Pitzer, Activity Coefficients in Electrolyte Solutions 2nd ed., CRC-Press, 1991, Chapt. 3, Ion Interaction Approach: Theory and Data Correlation; the parameters were matched to measured data).

To estimate the absorption medium capacity, the following assumptions were made:

1. The absorber is exposed at a total pressure of one bar to a CO₂-comprising flue gas of 0.13 bar CO₂ partial pressure (=13% CO₂ content).

2, In the absorber bottom, a temperature of 40° C. prevails.

3. During the regeneration, a temperature of 120° C. prevails in the desorber bottom.

4. In the absorber bottom, an equilibrium state is achieved, that is the equilibrium partial pressure is equal to the feed gas partial pressure of 13 kPa.

5. During the desorption, a CO₂ partial pressure of 5 kPa prevails in the desorber bottom (the desorption is typically operated at 200 kPa. At 120° C. pure water has a partial pressure of about 198 kPa. In an amine solution the partial pressure of water is somewhat lower, therefore a CO₂ partial pressure of 5 kPa is assumed).

6. During the desorption, an equilibrium state is achieved.

The capacity of the absorption medium was determined from (i) the loading (mole of CO₂ per kg of solution) at the intersection of the 40° C. equilibrium curve with the line of constant feed gas CO₂ partial pressure of 13 kPa (loaded solution at the absorber bottom in equilibrium); and (ii) from the intersection of the 120° C. equilibrium curve with the line of constant CO₂ partial pressure of 5 kPa (regenerated solution at the desorber bottom in equilibrium). The difference between the two loadings is the circulation capacity of the respective solvent. A high capacity means that less solvent need be circulated and thus the apparatuses such as, for example, pumps, heat exchangers, but also the piping, can be dimensioned so as to be smaller. In addition, the circulation rate also influences the energy required for regeneration.

A further measure of the service properties of an absorption medium is the gradient of the working lines in the McCabe-Thiele diagram (or p-X diagram) of the desorber. For the conditions in the bottom of the desorber, the working line is generally very close to the equilibrium line, so that the gradient of the equilibrium curve to an approximation can be equated to the gradient of the working line. At a constant liquid loading, for the regeneration of an absorption medium having a high gradient of equilibrium curve, a smaller amount of stripping steam is required. The energy requirement to generate the stripping steam makes an important contribution to the total energy requirement of the CO₂ absorption process.

Expediently, the reciprocal of the gradient is reported, since this is directly proportional to the amount of steam required per kilogram of absorption medium. If the reciprocal is divided by the capacity of the absorption medium, this gives a comparative value which directly enables a relative statement on the amount of steam required per absorbed amount of CO₂.

In table 2, the values of the absorption medium capacity and the steam requirement are standardized to the mixture of MDEA/piperazine. In table 3, the values of the absorption medium capacity and the steam requirement are standardized to the mixture of MDEA/MAPA.

It can be seen that absorption media having a tertiary amine whose reaction enthalpy Δ_{R}H of the protonation reaction is greater than that of methyidiethanolamine have a higher capacity and require a lower amount of steam for regeneration.

TABLE 2

| | Relative | Relative required |
|---|---|---|
| Absorption medium | capacity [%] | amount of steam [%] |
| Niax (37%)/piperazine (3%) | 162 | 52 |
| TMPDA (37%)/piperazine (3%) | 186 | 57 |
| MDEA (37%)/MAPA (3%) | 100 | 100 |

TABLE 3

| | Relative | Relative required |
|---|---|---|
| Absorption medium | capacity [%] | amount of steam [%] |
| Niax (37%)/MAPA (3%) | 162 | 43 |
| MDEA (37%)/MAPA (3%)* | 100 | 100 |
| TMPDA (37%)/MAPA (3%) | 180 | 69 |
| DMEA (37%)/MAPA (3%) | 174 | 70 |
| DEEA (37%)/MAPA (3%) | 180 | 72 |

*comparative example

1. A process for removing carbon dioxide from a gas stream in which the partial pressure of the carbon dioxide in the gas stream is less than 200 mbar, which comprises bringing the gas stream into contact with a liquid absorption medium which comprises an aqueous solution of
(A) an amine compound containing at least two tertiary amino groups in the molecule and
(B) an activator which is selected from primary and secondary amines.

2. A process for removing carbon dioxide from a gas stream in which the partial pressure of the carbon dioxide in the gas stream is less than 200 mbar, which comprises bringing the gas stream into contact with a liquid absorption medium which comprises an aqueous solution of
(A) a tertiary aliphatic amine and
(B) an activator which is selected from 3-methylaminopropylamine, piperazine, 2-methylpiperazine, N-methylpiperazine, homopiperazine, piperidine and morpholine, wherein the tertiary aliphatic amine A is characterized by a reaction enthalpy Δ_{R}H of the protonation reaction
A⁺H⁺→AH⁺
which is greater than that of methyldiethanolamine.

3. The process according to claim 1, wherein the amine compound has the general formula
R^{a}R^{b}N—X—NR^{a}′R^{b}′,
where R^{a}, R^{b}, R^{a}′ and R^{b}′ independently of one another are selected from C₁-C₆-alkyl groups, C₂-C₆-hydroxyalkyl groups or C₁-C₆-alkoxy-C₂-C₆-alkyl groups and X is a C₂-C₆-alkylene group, —X′—NR—X²— or —X¹O—X²—, where X¹ and X² independently of one another are C₂-C₆-alkylene groups and R is a C₁-C₆-alkyl group.

4. The process according to claim 3, wherein the amine compound is selected from N,N,N′,N′-tetramethylethylenediamine, N,N-diethyl-N′,N′-dimethylethylene-diamine, N,N,N′,N′-tetraethylethylenediamine, N,N,N′,N′-tetramethyl-1,3-propanediamine N,N,N′,N′-tetraethyl-1,3-propanediamine and bis(dimethylaminoethyl) ether.

5. The process according to claim 1, wherein the activator is selected from
a) 5- or 6-membered saturated heterocycles containing at least one NH group in the ring or
b) compounds of the formula R¹—NH—R²—NH₂, where R¹ is C₁-C₆-alkyl and R² is C₂-C₆-alkylene.

6. The process according to claim 5, wherein the activator is selected from piperazine, 2-methylpiperazine, N-methylpiperazine, homopiperazine, piperidine and morpholine.

7. The process according to claim 5, wherein the activator is 3-methylaminopropylamine.

8. The process according to claim 1, wherein the concentration of the amine compound is from 20 to 60% by weight and the concentration of the activator is from 1 to 10% by weight, based on the total weight of the absorption medium.

9. The process according to claim 1, wherein the gas stream results from
a) the oxidation of organic substances,
b) the composting or storage of waste material containing organic substances, or
c) the bacterial decomposition of organic substances.

10. The process according to claim 1, wherein the loaded absorption medium is regenerated by
a) heating,
b) expansion,
c) stripping with an inert fluid
or a combination of two or all of these measures.

11. The process according to claim 10, wherein the loaded absorption medium is regenerated by heating at a pressure of from 2 to 10 bar.

12. An absorption medium for removing carbon dioxide from a gas stream comprising an aqueous solution of
(A) an amine compound of the formula
R^{a}R^{b}N—X—NR^{a}R^{b},
where R^{a}, R^{b}, R^{a}′ and R^{b}′ independently of one another are selected from C₁-C₆-alkyl groups, C₂-C₆-hydroxyalkyl groups or C₂-C₆-alkoxy-C₂-C₆-alkyl groups and X is a C₂-C₆-alkylene group, —X¹—NR—X²— or —X—O—X²—, where X¹ and X² independently of one another are C₂-C₆-alkylene groups and R is a C₁-C₆-alkyl group,
(B) an activator which is selected from primary and secondary amines.

13. An absorption medium for removing carbon dioxide from a gas stream, comprising an aqueous solution of
(A) a tertiary aliphatic amine and
(B) an activator which is selected from 3-methylaminopropylamine, piperazine, 2-methylpiperazine, N-methylpiperazine, homopiperazine, piperidine and morpholine, wherein the tertiary aliphatic amine A is characterized by a reaction enthalpy Δ_{R}H of the protonation reaction
A+H⁺→AH+
which is greater than that of methyldiethanolamine.

14. The absorption medium according to claim 13, wherein the tertiary aliphatic amine is selected from N,N-diethylethanolamine, N,N-dimethylethanolamine, 2-diisopropylaminoethanol, N,N,N′,N′-tetramethylethylenediamine, N,N-diethyl-N′,N′-dimethylethylenediamine, N,N,N′,N′-tetraethylethylenediamine, N,N,N′,N′-tetramethyl-1,3-propanediamine, N,N,N′,N′-tetraethyl-1,3-propanediamine and bis(dimethylaminoethyl) ether.

15. The process according to claim 2, wherein the amine compound has the general formula
R^{a}R^{b}N—X—NR^{a}′R^{b}′
where R^{a}, R^{b}, R^{a}′ and R^{b}′ independently of one another are selected from C₁-C₆-alkyl groups, C₂-C₆-hydroxyalkyl groups or C₁-C₆-alkoxy-C₂-C₆-alkyl groups and X is a C₂-C₆-alkylene group, —X¹—NR—X²— or —X¹—O—X²—, where X¹ and X² independently of one another are C₂-C₆-alkylene groups and R is a C₁-C₆-alkyl group.

16. The process according to claim 2, wherein the activator is selected from
a) 5- or 6-membered saturated heterocycles containing at least one NH group in the ring or
b) compounds of the formula R¹—NH—R²—NH₂, where R¹ is C₁-C₆-alkyl and R² is C₂-C₆-alkylene.

17. The process according to claim 3, wherein the activator is selected from
a) 5- or 6-membered saturated heterocycles containing at least one NH group in the ring or
b) compounds of the formula R¹—NH—R²—NH₂, where R¹ is C₁-C₆-alkyl and R² is C₂-C₆-alkylene.

18. The process according to claim 4, wherein the activator is selected from
a) 5- or 6-membered saturated heterocycles containing at least one NH group in the ring or
b) compounds of the formula R¹—NH—R²—NH₂, where R¹ is C₁-C₆-alkyl and R² is C₂-C₆-alkylene.

19. The process according to claim 2, wherein the concentration of the amine compound is from 20 to 60% by weight and the concentration of the activator is from 1 to 10% by weight, based on the total weight of the absorption medium.

20. The process according to claim 3, wherein the concentration of the amine compound is from 20 to 60% by weight and the concentration of the activator is from 1 to 10% by weight, based on the total weight of the absorption medium.
